(19) United States
(12) Patent Application Publication
(10) Pub. No.: US 2025/0305606 A1
(43) Pub. Date: Oct. 2, 2025

(54) Modular Cryogenic Fluid High Voltage Transfer Line

(71) Applicant: Tai-Yang Research Company, Powell, TN (US)

(72) Inventors: Christopher M. Rey, Powell, TN (US); Benjamin S. Andrews, Tallahassee, FL (US)

(73) Assignee: Tai-Yang Research Company, Powell, TN (US)

(21) Appl. No.: 19/093,880

(22) Filed: Mar. 28, 2025

Related U.S. Application Data
(60) Provisional application No. 63/571,055, filed on Mar. 28, 2024.

(51) Int. Cl. F16L 25/02; F16L 59/065

(52) U.S. Cl. CPC F16L 25/026; F16L 59/065

(57) ABSTRACT

A CVL passes a cryogenic fluid without substantially reducing any voltage difference across it. A cylindrical inner vessel of an electrically insulating material is placed inside of a cylindrical outer vessel of an electrically insulating material. A first radial flange is disposed at the first end of the CVL, and is adapted to (1) form a hermetic seal between the inner vessel and the outer vessel, (2) space the inner vessel from the outer vessel so that they do not contact one another, and (3) provide an attachment point to the CVL. A second radial flange is disposed at the second end of the CVL, and is adapted to (1) form a hermetic seal between the inner vessel and the outer vessel, (2) space the inner vessel from the outer vessel so that they do not contact one another, and (3) provide an attachment point to the CVL.

### PRIORITY

This application claims priority on prior pending U.S. provisional patent application Ser. No. 63/571,055 filed 2024 Mar. 28, the entirety of the disclosure of which is incorporated herein as if laid out in full.

### FEDERAL RIGHTS

This disclosure was made with U.S. Government support under contract number DE-SC0021608 awarded by the Department of Energy. The government has certain rights in this disclosure.

### FIELD

This disclosure relates to the fields of cryogenic fluid (CF) transfer and voltage bushings used in electric power transmission. More particularly, this disclosure relates to transferring CF from an element at a relatively lower voltage to an element that at a relatively higher voltage.

### INTRODUCTION

Cryogenic fluid high voltage transfer lines (abbreviated as CVLs herein) are useful in a wide variety of applications including, but not limited to, electric power transmission, cryogenic fluid production, transportation, and storage, high energy and nuclear physics, fusion energy, magnetic resonance imaging, nuclear magnetic resonance, and hydrogen and natural gas extraction, production, transportation, and storage.

CVLs fall into two main rating types depending upon their location of use and function, which are a) indoor rated, and b) outdoor rated. CVLs rated for indoor use, where the environmental conditions such as ambient temperature, moisture, and humidity can be controlled, have different functional and environmental requirements than their outdoor variants, and tend to be less expensive to fabricate for an equivalent voltage rating. CVLs rated for outdoor use have different functional and environmental requirements than their indoor counterparts, and tend to be more expensive to fabricate for an equivalent voltage rating. CVLs rated for outdoor use may be used in indoor environments if desired. However, it is less common for CVLs rated for indoor use to be used in outdoor environments. CVLs are typically mounted either horizontally or vertically, depending upon the application, although any mounting angle is possible, depending upon the application.

CVLs are typically made of metallic components that are not rated for operation with a potential difference across them. Existing metallic CVLs are typically made of cryogenic compatible metals such as 300 series stainless steel or certain types of cryogenically compatible aluminum alloys. Existing CVLs come in a variety of shapes, sizes, lengths, and mechanical flexibilities. Flexible CVLs are typically fabricated using corrugated 300-series stainless steels or corrugated aluminum alloys. Existing metallic CVLs cannot simultaneously transfer a CF while maintaining a potential difference between a lower voltage component and a higher potential component.

What is needed, therefore, is a CVL that tends to reduce issues such as those described above, at least in part.

### SUMMARY

The above and other needs are met by a cryogenic fluid voltage transfer line (CVL) having a first end and second end. The CVL receives and passes a cryogenic fluid without substantially reducing any voltage difference between the first and second ends. A cylindrical inner vessel of a first electrically insulating material is place inside of a cylindrical outer vessel formed of second electrically insulating material, wherein the inner vessel does not physically contact the outer vessel. A first radial flange is disposed at the first end of the CVL, where the first radial flange is adapted to (1) form a first hermetic seal at the first end between the inner vessel and the outer vessel, (2) space the inner vessel from the outer vessel so that the inner vessel and the outer vessel do not contact one another at the first end, and (3) provide a first attachment point to the CVL at the first end. A second radial flange is disposed at the second end of the CVL, where the second radial flange is adapted to (1) form a second hermetic seal at the second end between the inner vessel and the outer vessel, (2) space the inner vessel from the outer vessel so that the inner vessel and the outer vessel do not contact one another at the second end, and (3) provide a second attachment point to the CVL at the second end.

In some embodiments according to this aspect of the disclosure, a thermally insulating vacuum drawn between the inner vessel and the outer vessel. In some embodiments, a vacuum getter material is disposed between the inner vessel and the outer vessel. In some embodiments, an electrically insulating and thermally insulating material is disposed between the inner vessel and the outer vessel. In some embodiments, a radial shed is disposed on an outer surface of the outer vessel. In some embodiments, a resistor is electrically connected at one end to the first flange and electrically connected at another end to the second flange. In some embodiments, an electrically insulating reflective coating is disposed between the inner vessel and the outer vessel. In some embodiments, a series of CVLs are physically connected one to another by the first and second flanges. In some embodiments, the first electrically insulating material and the second electrically insulating material are identical materials.

### DRAWINGS

Further advantages of the embodiments are apparent by reference to the detailed description when considered in conjunction with the figures, which are not to scale so as to more clearly show the details, wherein like reference numbers indicate like elements throughout the several views, and wherein:

FIG. 1 is a cross-sectional view showing the interior of a single module CVL rated for indoor use, according to an embodiment of the present disclosure.

FIG. 2 is a cross-sectional view showing the interior of a single module CVL rated for outdoor use, including multiple radial protrusions, generally referred to as sheds herein, according to an embodiment of the present disclosure.

FIG. 3 is an exterior view of a single module CVL with a known resistor located between the flanges, according to an embodiment of the present disclosure.

FIG. 4 is an exterior view of a CVL having multiple modules with known resistors located between the flanges, according to an embodiment of the present disclosure.

FIG. 5 is a cross-section view showing the interior of a single module CVL rated for indoor use, including an optional vacuum getter in the thermally insulating vacuum space, according to an embodiment of the present disclosure.

### DESCRIPTION

The terms, acronyms, and explanations listed below are provided for convenience and are not to be taken as binding for claim construction.

| Symbol | Definition | Units (if applicable) |
|---|---|---|
| AC | Alternating Current | Root mean squared current |
| | | in Amperes (Arms) |
| Al | Aluminum | Getter material |
| AM | Additive manufactured | 3D printed |
| ASTM | American Society for | Codes & Standards |
| | Testing & Materials | |
| CF | Cryogenic fluid | |
| CVL | Cryogenic fluid high | |
| | voltage transfer line | |
| CTI | Comparative tracking | |
| | index | |
| DC | Direct Current | Amperes (A) |
| ε₀ | Permittivity of free space | 8.84 × 10⁻¹² F/m |
| εᵣ | Relative permittivity | dimensionless |
| E-field | Electric field | V/m |
| FRP | Fiber reenforced plastics | |
| Δh | Height differential | m |
| IEC | International Electric | Codes & Standards |
| | Commission | |
| LCH4 | Liquid methane | Cryogenic fluid |
| LNG | Liquid natural gas | Cryogenic fluid |
| LH2/SH2 | Liquid hydrogen | Cryogenic fluid |
| LHe | Liquid helium | Cryogenic fluid |
| LN2/SN2 | Liquid nitrogen | Cryogenic fluid |
| LNe/SNe | Liquid/Solid neon | Cryogenic fluid |
| MLI | Multi-Layer-Insulation | |
| MRI | Magnetic resonance | |
| | imaging | |
| NMR | Nuclear magnetic | |
| | resonance | |
| ΔP | Pressure drop | bar, mbar Pa, etc. |
| ρ | Electrical resistivity | (Ω-m) |
| Re | Rare-earths | Getter material |
| ΔT | Temperature drop | K |
| Ta | Tantalum | Getter material |
| Ti | Titanium | Getter material |
| SiC | Silicon carbide | semiconductor |
| ΔV | Potential difference | V |

The various embodiments of this disclosure describe a CVL that can both thermally insulate CF in the CVL from its surroundings and simultaneously electrically isolate a component at one electric potential on one end of the CVL from a component at a different electric potential on the other end of the CVL. The embodiments described in this disclosure describe a CVL that can operate at low, medium, and high voltages in at least one of indoor and outdoor environments, while simultaneously transferring CF from a relatively lower voltage component to a relatively higher voltage component and vice-versa.

For the embodiments described in this disclosure, vertically mounted CVLs are described and depicted. However, this does not limit the applicability of the various embodiments to other mounting orientations. For the embodiments described in this disclosure, the CVLs are designed and rated for operation with a voltage across them while simultaneously transporting CF from one side to the other. The CVLs described in this disclosure can be rated for low, medium, or high voltages depending upon their design. There is no generally accepted definition of the voltage levels that constitute “low,” “medium,” and “high” voltages, so for the purposes of this disclosure the term low voltage is defined as <1 kV, medium voltage is defined as >1 kV and <33 kV, and high voltage is defined as anything >33 kV.

The voltage drop across the CVL can be from at least one of an AC voltage and a DC voltage. For the embodiments described in this disclosure, descriptions assume a medium to high voltage rating, however, one skilled in the art can adjust the design (such as at least one of shape, size, length, material type, number of sheds, surface treatments, and number of modules) for a particular voltage rating of the application.

With reference now to the drawings, there are depicted all of the claimed elements of the various embodiments, although all claimed embodiments might not be depicted in a single drawing. Thus, it is appreciated that not all embodiments include all of the elements as depicted, and that some embodiments include different combinations of the depicted elements. It is further appreciated that the various elements can all have many different configurations, and are not limited to just the configuration of a given element as depicted. As introduced above, the various elements of the drawings as depicted are not to scale, even with respect one to another, and relative size or thickness of one element cannot be determined by the aspect ratios of that element or with reference to any dimension of another element.

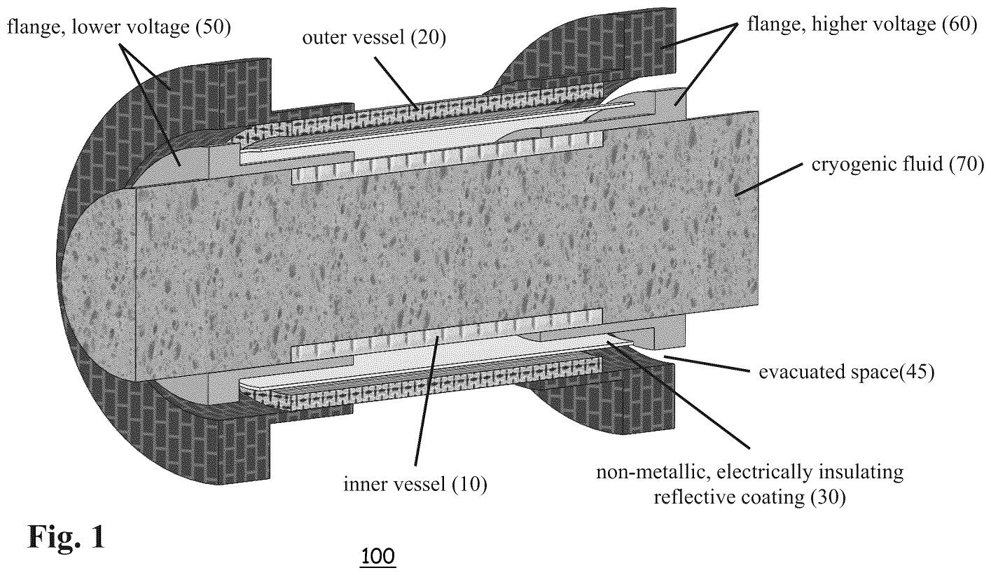

FIG. 1 depicts the cross-sectional view of an embodiment of single module CVL 100 rated for indoor use. The CVL 100 is comprised of an inner vessel 10, an outer vessel 20, an optional non-metallic, electrically insulating coating 30, a thermally insulating barrier such as an evacuated space 45 located between the inner vessel 10 and the outer vessel 20, at least one of a flange 50 on the relatively lower voltage side of the inner vessel 10 and outer vessel 20, and at least one of a flange 60 on the relatively higher voltage side of the inner vessel 10 and outer vessel 20. A CF 70 flows in the inner vessel 10 of CVL 100. The thermal barrier 45 is located between the inner vessel 10 and the outer vessel 20 limits the heat leak into the CF 70.

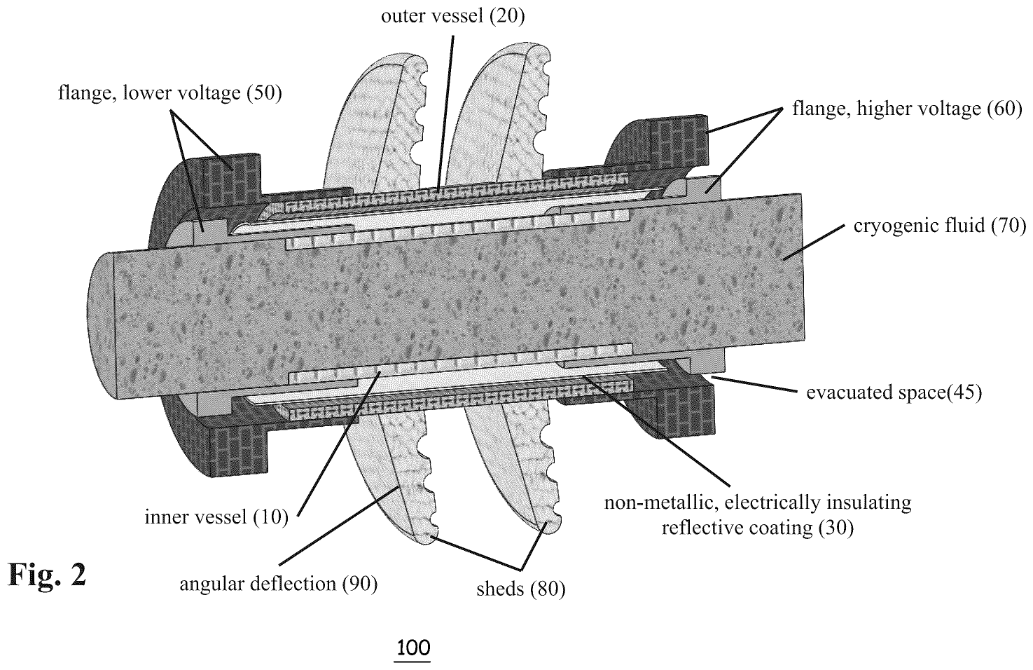

FIG. 2 depicts an embodiment of single module CVL 100 rated for outdoor use. The CVL 100 is comprised of an inner vessel 10, an outer vessel 20, an optional non-metallic, electrically insulating coating 30, a thermally insulating barrier such as an evacuated space 45 located between the inner vessel 10 and the outer vessel 20, at least one of a flange 50 on the lower voltage side of the inner vessel 10 and outer vessel 20, and at least one of a flange 60 of the relatively higher voltage side of the inner vessel 10 and outer vessel 20. A CF 70 flows in the inner vessel 10 of CVL 100. The CVL 100 rated for outdoor use typically includes radial protrusions referred to as sheds 80 on the outer vessel 20, which serve a multipurpose function. The sheds 80 may have an angular deflection 90 to drain water, moisture, and unwanted contaminants away. The exterior surface of the sheds 80 may be coated with a hydrophobic coating to further help remove water, ice, moisture, and so forth from the surfaces. The exterior surface of the sheds 80 may be fluorinated to help increase the voltage standoff capabilities

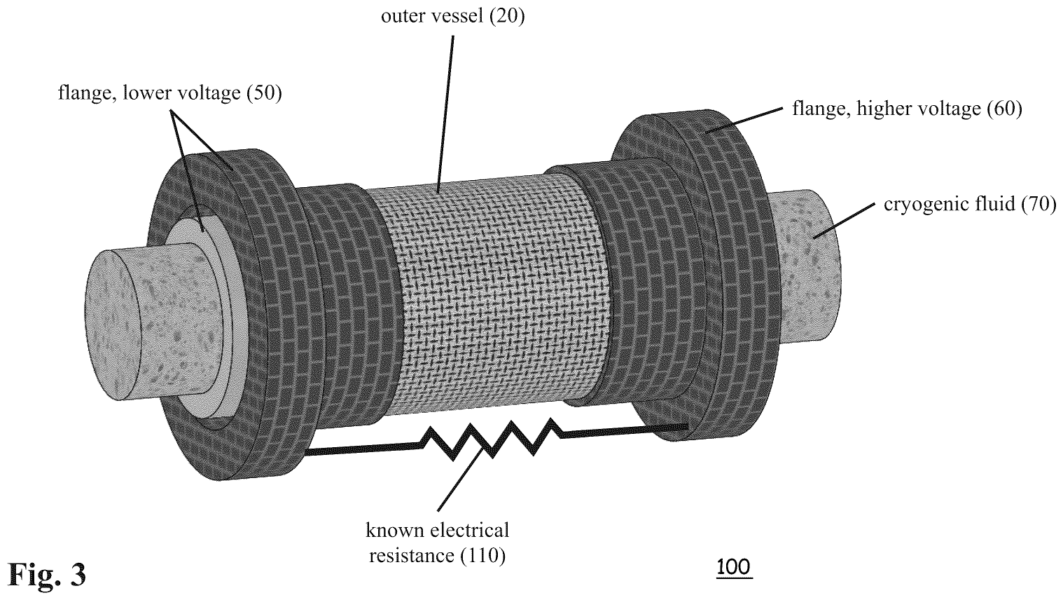

FIG. 3 depicts an embodiment of CVL 100 rated for indoor use. The CVL 100 in this embodiment has a known electrical resistor 110 electrically connected between the relatively lower voltage flange 50 and the relatively higher voltage flange 60. The known electrical resistor 110 in this embodiment is disposed external to the outer vessel 20 due to more limited space constraints within the interior of the CVL 100.

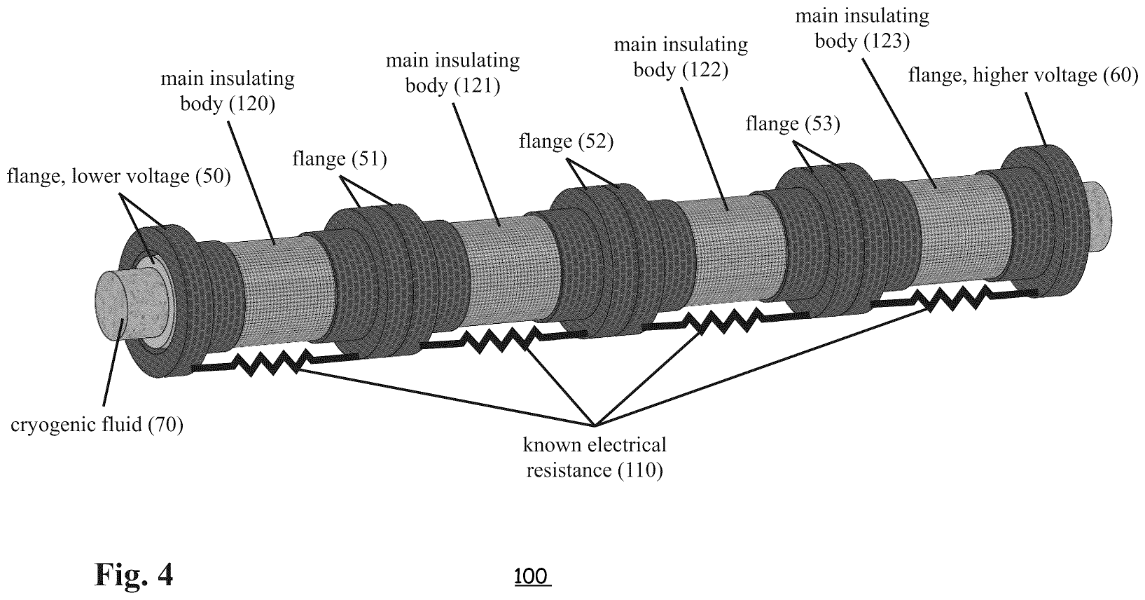

FIG. 4 depicts an embodiment of the CVL 100 rated for indoor use with multiple separate modules or instances of the CVL 100. The CVL 100 of this embodiment has at least one known electrical resistor 110 spanning the main electrically insulating body 120 between the relatively lower voltage flange 50 and the relatively higher voltage flange 51, 51 to 52, 52 to 53, and 53 to 60. Electrical resistors 110 can be used to span the main insulating bodies 120, 121, 122, and 123 of all four modules.

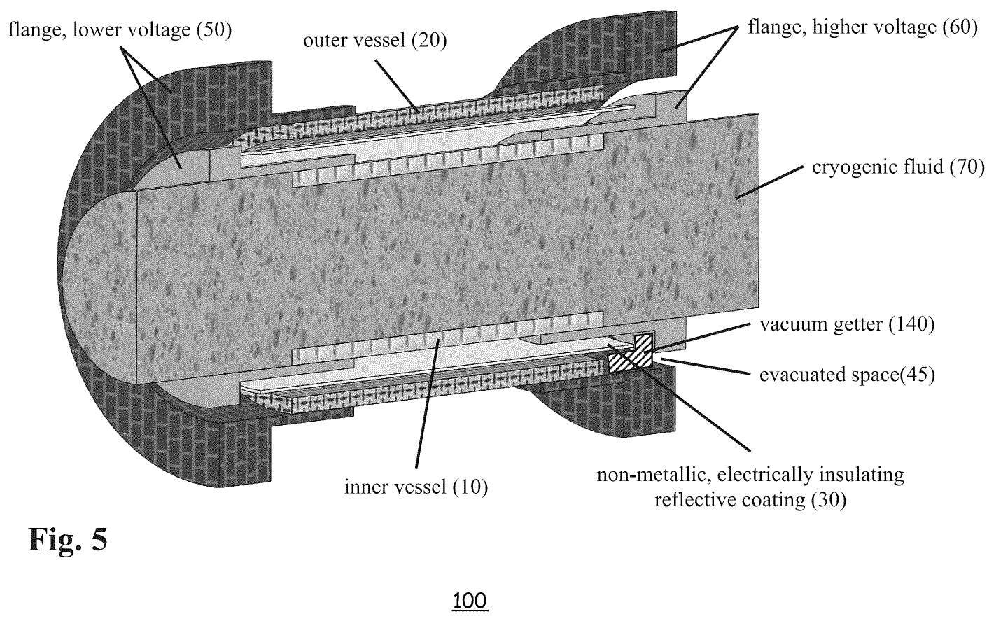

FIG. 5 depicts a cross-sectional view of an embodiment of single module CVL 100 rated for indoor use. The CVL 100 includes an inner vessel 10, an outer vessel 20, an optional non-metallic, electrically insulating coating 30, a thermally insulating barrier such as an evacuated space 45 located between the inner vessel 10 and the outer vessel 20, at least one of a flange 50 on the relatively lower voltage side of the inner vessel 10 and outer vessel 20, and at least one of a flange 60 on the relatively higher voltage side of the inner vessel 10 and outer vessel 20. The CVL 100 of this embodiment includes a vacuum getter material to help maintain the vacuum integrity of the CVL 100 over a prolonged period of time. A CF 70 flows in the inner vessel 10 of CVL 100.

CVLs 100 100 in the various embodiments described herein are generally formed of at least one of a) an inner vessel 10, b) an outer vessel 20, c) a thermally insulating barrier 45 such as a vacuum space located between the inner vessel 10 and the outer vessel 20, d) a flange 50 located on the relatively lower voltage side of both the inner vessel 10 and outer vessel 20, and e) a flange 60 located on the relatively higher voltage side of both the inner vessel 10 and the outer vessel 20. The inner vessel 10 carries CF 70 as it is transferred from one location to another. In some embodiments, the size (such as at least one of diameter and length) of the inner vessel 10 depends upon the specific requirements (such as at least one of CF 70 flow rate and potential difference) of the application. The outer vessel 20 forms the outermost structural boundary of the CVL 100. In some embodiments the size of the outer vessel 20 (such as at least one of diameter and length) depends upon the specific requirements (such as at least one of CF 70 flow rate and potential difference) of the application.

In various embodiments, the thermal barrier 45 (such as the vacuum) thermally insulates the CF 70 being transferred in the inner vessel 10 from the ambient outside, using at least one of vacuum, reflective layers of insulation, solid insulation, and vacuum getters. If vacuum is used as the thermal barrier 45, the vacuum space tends to reduce heat transfer via thermal conduction and convection from the relatively hotter outer vessel 20 wall to the relatively colder inner vessel 10 wall. The higher the vacuum (lower the pressure), the better the insulating properties generally tend to be, and hence the lower the heat leak to the CF 70. It can be advantageous in some embodiments to reach vacuum levels that are less than 10⁻⁵ mbar. For the embodiments described in this disclosure, the “main body” of the CVL 100 refers to the materials and parts located between the flanges 50/60 at each end of the CVL 100, and are preferably comprised of at least one electrically insulating material.

In some embodiments, the CVL 100 includes at least one of a) a layer of a non-metallic, electrically insulating, reflective material 30 around at least one of the outer wall of the inner vessel 10 and the inner wall of the outer vessel 20, b) a valves that controls the rate of flow of CF 70 between the relatively lower voltage side and the relatively higher voltage side of the CVL 100, c) a known electrical resistor 110 between the flange 50 on the relatively lower voltage side and the relatively higher voltage side, d) a vacuum getter in the vacuum space between the inner vessel 10 and the outer vessel 20, and e) an electrical connection between the inner vessel 10 flange and the outer vessel 20 flange.

The layer of reflective material 30 tends to reduce the radiant heat transfer from the relatively hot inner wall of the outer vessel 20 to the relatively cold outer wall of the inner vessel 10 transporting the CF 70. This reflective material 30 is generally referred to as multi-layer insulation (MLI) hereon. For the embodiments described in this disclosure, an electrically conducting insulation layer is not suitable for use as the MLI, because it will electrically short the relatively higher voltage side to the relatively lower voltage side, rendering the CVL 100 ineffective for the purposes as described herein. The MLI for the embodiments described herein are both reflective and electrically insulating, such as at least one of barium sulfate (such as Spectrflect™), titanium dioxide, Durflect™, and other types of non-metallic reflective coatings.

In some embodiments of the CVL 100, the insulating body is comprised of an electrically insulating and cryogenically compatible composite material including, but not limited to, polyetherimide, glass-filled polyetherimides, polyimide, thermoplastic, fiber reinforced plastics, and polytetrafluoroethylene, among other electrically insulating and cryogenically compatible materials.

In other embodiments of the CVL 100, the insulating body is formed of an electrically insulating and cryogenically compatible ceramic material including, but not limited to, porcelain, alumina doped porcelain, silica doped porcelain, and other electrically insulating and cryogenically compatible ceramic materials.

In some embodiments of the CVL 100, the parts are formed of machined or subtractive manufactured parts. In other embodiments of the CVL 100, the parts are formed of additive manufactured parts. Additive manufactured parts are sometime referred to as 3D printed parts and for the embodiments described in this disclosure, the terms are used interchangeably. In yet other embodiments of the CVL 100, the parts are made of a combination of machined and 3D printed parts.

In some embodiments, the electrically insulating 3D printed material is partially doped with semi-conducting filler materials, such as carbon, carbon fiber, carbon nano-tubes, or silicon carbide, to help smooth out the relative dielectric permittivity (εᵣ) between the relatively high voltage end and the relatively lower voltage end.

In some embodiments, the CVLs 100 100 transfers CF 70 from the relatively lower voltage end to the relatively higher voltage end. In other embodiments, the CVL 100 transfers CF 70 from the relatively higher voltage end to the relatively lower voltage end. Although a detailed description is given in which a CF 70 is transferred from a relatively lower voltage component to a relatively higher voltage component, it is also contemplated to transfer CF 70 from the relatively higher voltage end to the relatively lower voltage end.

There are several embodiments to transfer CF 70 from one end to the other end, including but not limited to, at least one of a pressure gradient and an external pump. The pressure gradient itself can be the result of a temperature gradient, gravity fed via a difference in CF 70 height, an external pressure cylinder, and other methods of developing a pressure gradient to transfer CF 70 between one end of the CVL 100 and the other.

In some embodiments of the CVL 100, some or all of the parts are rated for outdoor use. To keep the CVL 100 compact in the axial direction, CVLs 100 100 rated for outdoor use typically use radial protrusions to increase the length of the voltage creep path, although other protrusions designs are possible. These radial protrusions are called sheds 80 herein, but can also be called pucks, flutes, waffles, bushings, high voltage boosters, and so forth. The sheds 80 are designed to protect against flashovers caused by exterior wetting or ice build-up. Voltage flashovers can occur, for example, during live-line washing or torrential rain. The shed 80 works by breaking up long cascades of lightly contaminated water, cooling, compressing, and extinguishing any discharges that runs between it and the insulator. The sheds 80 act as an arc-chute or expulsion tube to eject heavy current arcs from the underside.

The size, shape, footprint, extended angle, surface roughness, surface coating, and so forth of the sheds 80 tend to be application dependent. The comparative tracking index of the shed 80 or main insulating body is used to measure the electrical breakdown (tracking) properties of an insulating material. Tracking is an electrical breakdown on the surface of an insulating material, wherein an initial exposure to electrical arcing heat carbonizes the material. The carbonized areas are more conductive than the pristine insulator, increasing current flow, resulting in increased heat generation, and eventually the insulation becomes completely conductive. A large voltage difference gradually creates a conductive leakage path across the surface of the material by forming a carbonized track.

In some embodiments, the CVL 100 is rated for outdoor use, the sheds 80 are angled or pitched so that water, moisture, contaminants, and ice do not build up on the surface of the shed. Various elements of sheds, such as angle, pitch, radial length, surface finish, and surface coating can be selected, depending upon the application.

In some embodiments of the CVL 100 rated for outdoor use, the exterior surface of the sheds 80 are coated with a relatively hydrophobic coating. The hydrophobic coating helps repel water, moisture, ice build-up, and contaminants that can lead to unwanted voltage flashover and tracking along its surface. The exterior surface of the sheds 80 may also be fluorinated for increase in voltage standoff.

In some embodiments of the CVL 100 rated for outdoor use, the sheds 80 are ribbed to further enhance or extend the voltage creep path.

In some embodiments of the CVL 100, some or all of the parts of the CVL 100 are rated for indoor use. CVLs 100 100 rated for indoor use may or may not use a shed 80 to aid in making a more axially compact CVL 100. CVLs 100 100 rated for indoor use may or may not be coated with hydrophobic coatings to repel water, moisture, ice build-up, contaminants, and so forth.

In some embodiments of the CVL 100, at least one or more vacuum getter is located in-between the inner vessel 10 wall and the outer vessel 20 wall. A getter is a deposit of reactive material that is placed inside a vacuum system to complete and maintain the vacuum. When gas molecules strike the getter material, they combine chemically or by absorption. Thus, the getter removes small amounts of gas from the evacuated space. The type of getter or absorptive material that is used depends upon the gas species it is trying to absorb. Some common types of getter material include, but are not limited to, activated charcoal, aluminum, barium, magnesium, rare-earths, titanium, and tantalum.

In some embodiments of the CVL 100, the thermal insulation between the inner vessel 10 and the outer vessel 20 is provided by a vacuum barrier 45. Vacuum pressures less than about 10⁻⁵ mbar are desired in some embodiments, where the lower the pressure (meaning the higher the vacuum) the better the thermally insulating properties. In other embodiments of the CVL 100, the thermal insulating barrier 45 is provided by a solid material. There are many materials that are used as the thermal barrier 45 in various embodiments, such as polystyrene, silica gels, glass beads, and amorphous volcanic glass. In still other embodiments of the CVL 100, the thermally insulating barrier 45 between the inner vessel 10 and the outer vessel 20 is a combination of vacuum and solid insulation, or some other combination of thermally insulating materials.

In some embodiments of the CVL 100, at least one known electrical resistor 110 is used. This known resistor 110 is electrically connected between the flanges 50/60 located at each end of the CVL 100, and is electrically connected in parallel with the main insulating body of the CVL 100. The known electrical resistor 110 allows for a controlled linear or near linear drop in voltage from the relatively higher voltage side to the relatively lower voltage side. In some embodiments, a linear, near linear, or stair-step drop in voltage is provided between the relatively lower voltage side and the relatively higher voltage side. Without the use of the known resistor 110 in parallel with the main electrically-insulating body, the voltage drop can become highly non-linear, which could result in unwanted, premature voltage flashover or voltage tracking along the insulating main body. The known resistor 110 controls the amount of leakage current from one flange 50/60 to the next.

In some embodiments, the value of electrical resistance for the resistor 110 is selected to be much less than the electrical resistance of the main insulating body of the CVL 100, thus for resistor 110s in parallel, the value of electrical resistance is dominated by the larger value resistor 110, with the majority of the current flow being through the smaller known resistor 110. Common electrical resistance values of these known resistor 110s range, in various embodiments, from a few MΩ to tens of GΩs, depending upon the application. In other embodiments, no known resistor 110s are used.

In some embodiments of the CVL 100, there are flanges 50/60 located at each end of the CVL 100. The flanges 50/60 are located on both the outer vessel 20 and inner vessel 10. There are many types of cryogenically rated end flanges 50/60 that could be used, including but not limited to, Conflat™ flanges, ISO flanges, quick connect flanges, welds stubs, weld tubes, flared fittings, threaded fittings, and Swagelok™ fittings. If ISO or quick connect flanges are used, then appropriate cryogenically rated O-rings can be used.

In some embodiments of the CVL 100, there is at least one relatively low resistance electrical connection between the inner vessel 10 flange 50/60 and the outer vessel 20 flange 50/60 on the relatively lower voltage side. Such a relatively low resistance electrical connection tends to reduce potential differences between the flanges 50/60 that are located on the same voltage side. In other embodiments of the CVL 100, there is at least one connection between the inner vessel 10 flange 60 and the outer vessel 20 flange 60 on the relatively higher voltage side. In some embodiments, these relatively low resistance electrical connections are selected to reduce heat transfer between the two flanges.

In some embodiments of the CVL 100, the main insulating body of the inner and outer vessel 20s is cylindrically shaped. However, in various embodiments, other shapes are used, such as, but not limited to, spherical, rectangular, parallelepiped, and cubicle.

In some embodiments of the CVL 100, CF 70 transferred from one voltage side to another is liquid nitrogen. However, other types of CF 70s are contemplated, such as liquid helium, liquid hydrogen, liquid neon, liquid nitrogen, liquid air, liquid oxygen, liquid argon, liquid xenon, liquid natural gas, liquid methane, and liquid XF6. In some embodiments of the CVL 100, CF 70 transferred from one end of the CVL 100 to the other is pressurized, sub-cooled via reduced pressure, single phase supercritical fluids, and two-phase fluids.

As used herein, the phrase “at least one of A, B, and C” means all possible combinations of none or multiple instances of each of A, B, and C, but at least one A, or one B, or one C. For example, and without limitation: Ax1, Ax2+Bx1, Cx2, Ax1+Bx1+Cx1, Ax7+Bx12+Cx113. It does not mean Ax0+Bx0+Cx0.

The foregoing description of embodiments has been presented for purposes of illustration and description. It is not intended to be exhaustive or to limit the embodiments to the precise form disclosed. Obvious modifications or variations are possible in light of the above teachings. The embodiments are chosen and described in an effort to provide illustrations of the principles of the embodiments and their practical application, and to thereby enable one of ordinary skill in the art to utilize the various embodiments and with various modifications as are suited to the particular use contemplated. All such modifications and variations are within the scope of the embodiments as determined by the appended claims when interpreted in accordance with the breadth to which they are fairly, legally, and equitably entitled.

1. A cryogenic fluid voltage transfer line (CVL) having a first end and second end, the CVL adapted to receive and pass a cryogenic fluid through the CVL and not reduce any voltage difference between the first end and the second end of the CVL, the CVL comprising:
a cylindrical inner vessel formed of a first electrically insulating material and having a first outer diameter,
a cylindrical outer vessel formed of second electrically insulating material and having a second inner diameter,
wherein the first diameter is smaller than the second diameter,
the inner vessel disposed inside the outer vessel,
wherein the inner vessel does not physically contact the outer vessel,
a first radial flange disposed at the first end of the CVL, the first radial flange adapted to,
form a first hermetic seal at the first end between the inner vessel and the outer vessel,
space the inner vessel from the outer vessel so that the inner vessel and the outer vessel do not contact one another at the first end, and
provide a first attachment point to the CVL at the first end, and
a second radial flange disposed at the second end of the CVL, the second radial flange adapted to,
form a second hermetic seal at the second end between the inner vessel and the outer vessel,
space the inner vessel from the outer vessel so that the inner vessel and the outer vessel do not contact one another at the second end, and
provide a second attachment point to the CVL at the second end.

2. The CVL of claim 1, further comprising a thermally insulating vacuum drawn between the inner vessel and the outer vessel.

3. The CVL of claim 2, further comprising a vacuum getter material disposed between the inner vessel and the outer vessel.

4. The CVL of claim 1, further comprising an electrically insulating and thermally insulating material disposed between the inner vessel and the outer vessel.

5. The CVL of claim 1, further comprising a radial shed disposed on an outer surface of the outer vessel.

6. The CVL of claim 1, further comprising a resistor electrically connected at one end to the first flange and electrically connected at another end to the second flange.

7. The CVL of claim 1, further comprising an electrically insulating reflective coating disposed between the inner vessel and the outer vessel.

8. The CVL of claim 1, further comprising a series of CVLs physically connected one to another by the first and second flanges.

9. The CVL of claim 1, wherein the first electrically insulating material and the second electrically insulating material are identical materials.

10. A CVL having a first end and second end, the CVL adapted to receive and pass a cryogenic fluid through the CVL and not reduce any voltage difference between the first end and the second end of the CVL, the CVL comprising:
a cylindrical inner vessel formed of a first electrically insulating material and having a first outer diameter,
a cylindrical outer vessel formed of second electrically insulating material and having a second inner diameter,
wherein the first diameter is smaller than the second diameter,
the inner vessel disposed inside the outer vessel,
wherein the inner vessel does not physically contact the outer vessel,
a radial shed disposed on an outer surface of the outer vessel,
a first radial flange disposed at the first end of the CVL, the first radial flange adapted to,
form a first hermetic seal at the first end between the inner vessel and the outer vessel,
space the inner vessel from the outer vessel so that the inner vessel and the outer vessel do not contact one another at the first end, and
provide a first attachment point to the CVL at the first end,
a second radial flange disposed at the second end of the CVL, the second radial flange adapted to,
form a second hermetic seal at the second end between the inner vessel and the outer vessel,
space the inner vessel from the outer vessel so that the inner vessel and the outer vessel do not contact one another at the second end, and
provide a second attachment point to the CVL at the second end, and
a resistor electrically connected at one end to the first flange and electrically connected at another end to the second flange.

11. The CVL of claim 10, further comprising a thermally insulating vacuum drawn between the inner vessel and the outer vessel.

12. The CVL of claim 11, further comprising a vacuum getter material disposed between the inner vessel and the outer vessel.

13. The CVL of claim 10, further comprising an electrically insulating and thermally insulating material disposed between the inner vessel and the outer vessel.

14. The CVL of claim 10, further comprising an electrically insulating reflective coating disposed between the inner vessel and the outer vessel.

15. The CVL of claim 10, further comprising a series of CVLs physically connected one to another by the first and second flanges.

16. The CVL of claim 10, wherein the first electrically insulating material and the second electrically insulating material are identical materials.
